(19) United States
(12) Patent Application Publication
(10) Pub. No.: US 2026/0189514 A1
(43) Pub. Date: Jul. 2, 2026

(54) APPARATUS AND METHOD FOR TIME-DETERMINISTIC PACKET FORWARDING USING NON-WORK CONSERVING STATELESS CORE FAIR QUEUING METHOD

(71) Applicant: ELECTRONICS AND TELECOMMUNICATIONS RESEARCH INSTITUTE, Daejeon (KR)

(72) Inventors: Yeon Cheol RYOO, Daejeon (KR); Jeong Dong RYOO, Daejeon (KR); Tae Sik CHEUNG, Daejeon (KR); Jinoo JOUNG, Daejeon (KR)

(73) Assignee: ELECTRONICS AND TELECOMMUNICATIONS RESEARCH INSTITUTE, Daejeon (KR)

(21) Appl. No.: 19/392,814

(22) Filed: Nov. 18, 2025

(30) Foreign Application Priority Data
Nov. 19, 2024 (KR) 10-2024-0165407
Nov. 18, 2025 (KR) 10-2025-0174586

(51) Int. Cl. H04L 47/629; H04L 47/80

(52) U.S. Cl. CPC H04L 47/629; H04L 47/805

(57) ABSTRACT

The present disclosure relates generally to time-deterministic packet forwarding technology, and more particularly, to an apparatus and method for time-deterministic packet forwarding using a non-work-conserving stateless core fair queuing method in a network. The method includes comparing the reception time of the packet with the finish time of the previous packet when receiving the packet, setting the larger value as the eligible time of the packet, and calculating the finish time of the packet by adding the value obtained by dividing the packet size by the set transmission rate to the eligible time. The method includes arranging packets with an earlier eligible time in a first priority queue in order of their earliest eligible time and restricting an output of the packets before the eligible time in a non-work-conserving manner, arranging packets whose eligible time has passed in a second priority queue in order of their earliest finish time, and outputting the packet in a work-conserving manner when there is no other packet to be served in the second priority

### TECHNOLOGY FIELD

The present disclosure relates generally to time-deterministic packet forwarding technology, and more particularly, to an apparatus and method for time-deterministic packet forwarding using a non-work-conserving stateless core fair queuing method.

### BACKGROUND OF THE DISCLOSURE

Recently, research and development have been underway in the field of network technology to secure not only bandwidth but also forwarding time.

Tactile Internet haptic applications, holographic-type communications (HTC), VR applications, and the like require rapid content forwarding within a maximum delay specified for each application to maintain user-perceived quality. Furthermore, industrial convergence networks for Industry 4.0 should ensure that control and telemetry data are forwarded on time to meet target deadlines for remotely controlled industries and robot automation.

To meet the requirements of these diverse applications, standardization of time-deterministic packet forwarding technologies is underway in IEEE 802.1 time-sensitive networking (TSN) and IETF's deterministic networking (DetNet) to guarantee quantified target times such as in-time and on-time.

Time-deterministic packet forwarding technologies defined in TSN may include time aware shaper (TAS), cyclic queuing and forwarding (CQF), and asynchronous traffic shaper (ATS), etc. the time-deterministic packet forwarding technologies defined by the detnet may include TAS-based timeslot queuing and forwarding (TQF), which improves the time synchronization of existing TSN technologies for wide area networks, COF-based cycle specified queuing and forwarding (CSQF), tagged CQF (TSCQF), and enhanced COF (ECQF). in addition, the time-deterministic packet forwarding technologies may include in-time and on-time forwarding methods that extend earliest deadline first (EDF), on-time forwarding methods that utilize priority queues (push in first out (PIFO) queue), c-score, which extends fair queuing (FQ), etc.

However, in a wide area network, periodically performing time synchronization between all nodes and managing the states of large-scale flows is burdensome. therefore, among the above-described various functional characteristics, technologies requiring time synchronization and state management are unsuitable for application to wide area networks. furthermore, methods having functional characteristics that determine service priorities based on time and manage a delay based on classes should consider input/output times, bandwidths, etc., of existing flows configured in the same class across all nodes when configuring a new flow, and require that class-specific configurations be predefined in advance. therefore, these methods face a problem of dramatically increasing management and control complexity as the network scale and the number of flows increase.

To meet the requirements of these diverse applications, standardization of time-deterministic packet forwarding technologies is underway in IEEE 802.1 Time-Sensitive Networking (TSN) and IETF's Deterministic Networking (DetNet) to guarantee quantified target times such as in-time and on-time.

### CONTENT OF THE INVENTION

### The Object of the Invention

Based on the above-described discussion, the present disclosure provides an apparatus and method for providing an on-time service that guarantees end-to-end maximum and minimum delays in a wide area network.

In addition, the present disclosure provides an apparatus and method for a time-deterministic packet forwarding technology that may operate efficiently without time synchronization or flow state management.

Furthermore, the present disclosure provides an apparatus and method for a queuing method that may provide a constant service period based on a transmission rate even for flows with aperiodic characteristics.

### TECHNICAL OBJECT OF THE INVENTION

According to one aspect of the present invention, a non-work-conserving stateless core fair queuing method for providing an on-time service that guarantees end-to-end maximum and minimum delays in a network includes: when receiving a packet, comparing a reception time of the packet with a finish time of a previous packet to set a larger value as an eligible time of the packet; calculating a finish time of the packet by adding a value obtained by dividing a size of the packet by a set transmission rate to the eligible time; arranging packets with an earlier eligible time in a first priority queue in order of their earliest eligible time and restricting an output of the packets before the eligible time in a non-work-conserving manner; arranging packets whose eligible time has passed in a second priority queue in order of their earliest finish time; and outputting the packet in a work-conserving manner when there is no other packet to be served in the second priority queue.

According to another aspect of the present invention, a non-work-conserving stateless core process queuing apparatus for providing an on-time service that guarantees end-to-end maximum and minimum delays in a network includes: a transceiver; and a processor operatively connected to the transceiver, in which the processor is configured to, when receiving a packet, compare a reception time of the packet with a finish time of a previous packet to set a larger value as an eligible time of the packet, calculate a finish time of the packet by adding a value obtained by dividing a size of the packet by a set transmission rate to the eligible time, arrange packets with an earlier eligible time in a first priority queue in order of their earliest eligible time and restrict an output of the packets before the eligible time in a non-work-conserving manner, arrange packets whose eligible time has passed in a second priority queue in order of their earliest finish time, and output the packet in a work-conserving manner when there is no other packet to be served in the second priority queue.

According to still another aspect of the present invention, a method of time-deterministic packet forwarding control using non-work-conserving stateless core fair queuing in a network includes: calculating a path and a transmission rate that satisfy operator requirements when a new time-deterministic flow is requested; confirming whether a sum of a transmission rate calculated for the new flow and transmission rates of other flows already configured on an output port of the path exceed a maximum transmission rate of the port; approving and configuring the new flow when the sum of the transmission rates does not exceed the maximum transmission rate; and determining end-to-end maximum and minimum delays and jitter for the configured flow according to a predetermined calculation formula.

According to still yet another aspect of the present invention, an apparatus for time-deterministic packet forwarding control using non-work-conserving stateless core fair queuing in a network includes: a transceiver; and a processor operatively connected to the transceiver, in which the processor is configured to calculate a path and a transmission rate that satisfy operator requirements when a new time-deterministic flow is requested, confirm whether a sum of a transmission rate calculated for the new flow and transmission rates of other flows already configured on an output port of the path exceed a maximum transmission rate of the port, approve and configure the new flow when the sum of the transmission rates does not exceed the maximum transmission rate, and determine end-to-end maximum and minimum delays and jitter for the configured flow according to a predetermined calculation formula.

### Effect of the Invention

The apparatus and method according to various embodiments of the present disclosure operate in a non-work-conserving manner to guarantee both the end-to-end maximum and minimum delays, thereby significantly reducing jitter compared to an existing work-conserving manner.

Furthermore, the apparatus and method according to various embodiments of the present disclosure operate in a stateless manner to eliminate the burden of state management for large-scale flows, thereby significantly improving scalability in a wide area network.

Effects which may be achieved by the present disclosure are not limited to the effects described in various embodiments. Other effects that are not mentioned may be obviously understood by those skilled in the art to which the present disclosure pertains from the following description.

### BRIEF DESCRIPTION OF THE DRAWINGS

FIG. 1 is a diagram illustrating packet-specific termination time calculations and service periods for C-SCORE according to various embodiments of the present disclosure.

FIG. 2 is a diagram illustrating packet-specific eligible time and finish time calculations and service periods for a non-work-conserving stateless core fair queuing method according to an embodiment of the present disclosure.

FIG. 3 is a diagram illustrating a queuing implementation of a non-work-conserving stateless core fair queuing method according to an embodiment of the present disclosure.

FIG. 4 is a diagram illustrating per-node service periods of the non-work-conserving stateless core fair queuing method according to an embodiment of the present disclosure.

FIG. 5 is an operational flowchart of the non-work-conserving stateless core fair queuing method according to an embodiment of the present disclosure.

FIG. 6 is an operational flowchart of a time-deterministic packet forwarding control method according to an embodiment of the present disclosure.

FIG. 7 is a configuration diagram of the time-deterministic packet forwarding apparatus according to an embodiment of the present disclosure.

### DETAILED DESCRIPTION OF THE EMBODIMENTS

Terms used in the present disclosure may be used only in order to describe specific exemplary embodiments rather than restricting the scope of other exemplary embodiments. Singular forms may include plural forms unless the context clearly indicates otherwise. All terms used herein including technical and scientific terms have the same meanings as those that are generally understood by those skilled in the art to which the present disclosure pertains. Terms defined in a general dictionary among terms used in the present disclosure may be interpreted with meanings that are the same as or similar to meanings within the context of the related art, and are not interpreted with ideal or excessively formal meanings unless clearly defined in the present disclosure. In some cases, terms may not be interpreted to exclude exemplary embodiments of the present disclosure even though they are defined herein.

In various embodiments of the present disclosure described below, a hardware approach will be described as an example. However, since various embodiments of the present disclosure include technology using both hardware and software, various embodiments of the present disclosure do not exclude a software-based approach.

Also, in the detailed description and claims of the present disclosure, “at least one of A, B, and C” means “only A,” “only B,” “only C,” or “any combination of A, B and C.” Also, “at least one of A, B, or C” or “at least one of A, B and/or C” may mean “at least one of A, B, and C.”

The present disclosure relates to an apparatus and method for time-deterministic packet forwarding using a non-work-conserving stateless core fair queuing method in a network. Specifically, the present disclosure describes a novel queuing technology that may guarantee both end-to-end maximum and minimum delays in a network to provide on-time service and operate efficiently without the burden of time synchronization and state management.

The terms used in the following description to refer to signals, channels, control information, network entities (network objects), device components, and the like are exemplified for the convenience of description. Accordingly, the present disclosure is not limited to terms described below, and other terms having equivalent technical meanings may be used.

In addition, although the present disclosure describes various embodiments using terms used in some communication standards (e.g., 3rd Generation Partnership Project (3GPP)), this is only an example for description. Various embodiments of the present disclosure may be easily modified and applied to other communication systems.

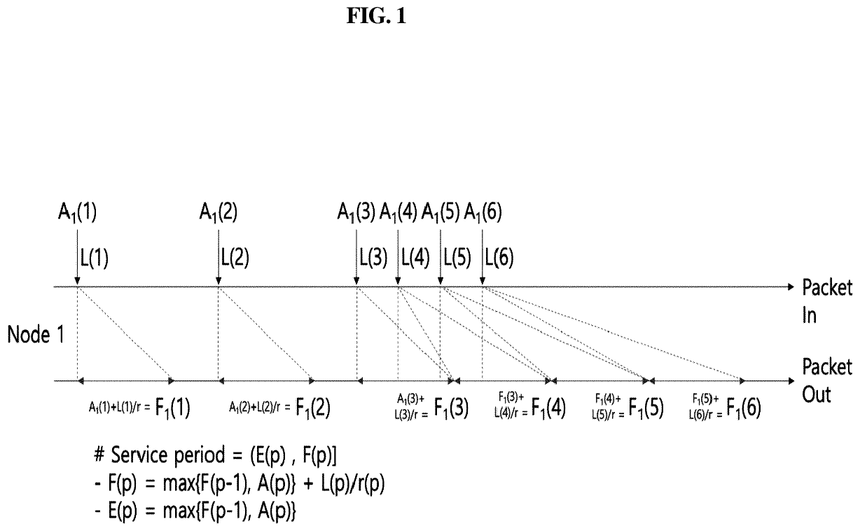

FIG. 1 is a diagram illustrating packet-specific termination time calculations and service periods for C-SCORE according to various embodiments of the present disclosure.

Referring to FIG. 1, the existing C-SCORE determines service priority based on a packet finish time F(p), which is calculated based on a transmission rate.

Looking at a process of sequentially receiving packets at node 1, reception times of each packet, A(1), A(2), A(3), A(4), A(5), and A(6), are indicated on a time axis. A finish time is calculated based on lengths L(1), L(2), L(3), L(4), L(5), and L(6) of packets 1 to 6, respectively, and a transmission rate r(p) configured for a flow.

The finish time calculation is based on Equation 1:

$$F ( p ) = max \{ F ( p - 1 ) , A ( p ) \} + L ( p ) / r ( p ) \qquad [ Equation 1 ]$$

Here, F(p) denotes the finish time of packet p, F(p−1) denotes the finish time of previous packet p−1, A(p) denotes the reception time of packet p, L(p) denotes a size of packet p, and r(p) denotes the transmission rate configured for packet p.

As illustrated in FIG. 1, since the finish time F1(1) of packet 1 is the first arriving packet, F1(0) is 0 and thus A(1) has a large value, the finish time is calculated as F1(1)=A(1)+L(1)/r, and since F1(3) is larger than A(4), the finish time F1(4) of packet 4 is calculated as F1(4)=F1(3)+L(4)/r. In this way, the finish time of each packet is sequentially calculated by comparing the finish time and reception time of the previous packet, and the finish time F1(6) up to packet 6 is derived.

C-SCORE arranges packets with the fastest calculated finish time in a priority queue in order, and outputs the packets immediately when there are no other packets to be serviced on a link in a work-conserving manner. Therefore, each packet has a service period of [A(p), F(p)], which is a period from packet reception to finish time, and exhibits in-time service characteristics.

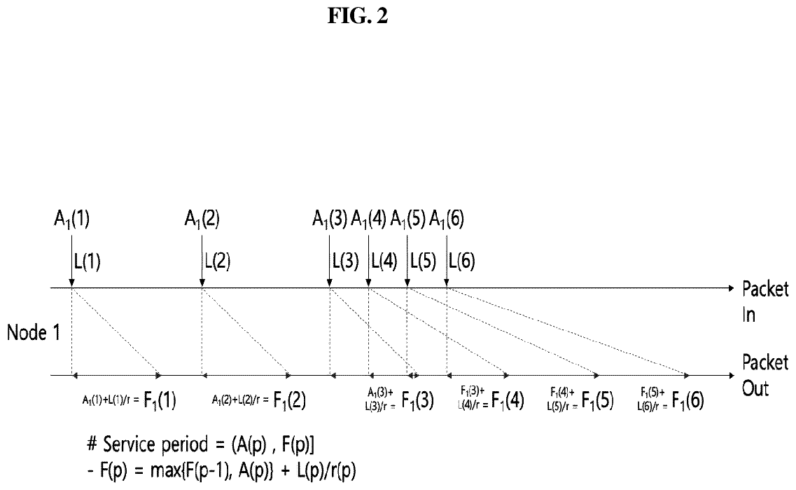

FIG. 2 is a diagram illustrating packet-specific eligible time and finish time calculations and service periods for a non-work-conserving stateless core fair queuing method according to an embodiment of the present disclosure.

Referring to FIG. 2, the method proposed in the present disclosure operates in a non-work-conserving manner by extending the existing C-SCORE and adding an eligible time E(p) for on-time packet forwarding.

Looking at the process of sequentially receiving packets at node 1, the reception times of each packet, A1(1), A1(2), A1(3), A1(4), A1(5), and A1(6), are indicated on the time axis.

FIG. 2 illustrates a burst situation in which packets 3, 4, 5, and 6 are received almost simultaneously.

In this method, two time values are calculated for each packet.

### Eligible Time Calculation:

$$E ( p ) = max \{ F ( p - 1 ) , A ( p ) \} \qquad [ Equation 2 ]$$

Here, E(p) denotes the eligible time of the packet p, F(p−1) denotes the finish time of the previous packet, and A(p) denotes the reception time of the packet p.

### Finish Time Calculation:

$$F ( p ) = E ( p ) + L ( p ) / r ( p ) \qquad [ Equation 3 ]$$

Here, F(p) denotes the finish time of the packet p, L(p) denotes the size of the packet p, and r(p) denotes the transmission rate configured for the packet p.

Looking at the calculation process for each packet illustrated in FIG. 2, since packet 1 is the first packet, and F1(0) is 0, the eligible time is calculated as E1(1)=A1(1) and the finish time is calculated as F1(1)=A1(1)+L(1)/r, and for packet 4, since F1(3) is larger than A1(4), the eligible time is calculated as E1(4)=F1(3) and the finish time is calculated as F1(4)=F1(3)+L(4)/r. Starting from packet 4, due to a burst condition in which the reception time is earlier than the finish time of the previous packet, the eligible time is set to the finish time of the previous packet, and the finish time is calculated by adding the packet length divided by the service rate to the finish time of the previous packet.

In this way, the eligible time and finish time are calculated for each of packets 4, 5, and 6, so all the packets have the same service period of [E(p), F(p)].

“Service period=(E(p), F(p)]” shown at the bottom of the drawing represents the core feature of the present method, which guarantees on-time service characteristics with a fixed interval from the eligible time to the finish time, unlike the (A(p), F(p)] service period of C-SCORE.

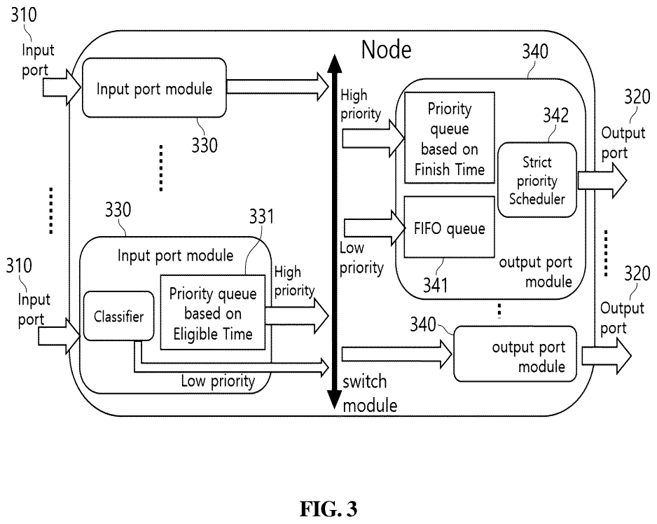

FIG. 3 is a diagram illustrating a queuing implementation of a non-work-conserving stateless core fair queuing method according to an embodiment of the present disclosure.

Referring to FIG. 3, the queuing structure of the present method extends the existing C-SCORE and is composed of a two-step priority queue system.

A network node 300 is located between an input port 310 and an output port 320 and is internally composed of an input port module 330 and an output port module 340.

The input port module 330 includes a classifier 331 and a priority queue based on an eligible time 332. Packets that have been received through the input port 310 are first classified on a per-flow basis by the classifier 331, and are then arranged into the priority queue based on the calculated eligible time E(p). The queue operates in a non-work-conserving manner, so the packets are not output until the eligible time is reached.

The output port module 340 includes a priority queue based on finish time 341 and a strict priority scheduler 342. Packets whose eligible time has passed are forwarded from the input port module 330 to the output port module 340 and rearranged in the priority queue based on the finish time 341 in the order of their finish time F(p). In addition, the output port module 340 may process various traffic classes as well as a FIFO queue.

There are high priority and low priority paths between the two modules, and the packets are forwarded to an appropriate path through the switch module. Packets whose eligible time has passed move to the output port module 340 via the high-priority path, and are output through the output port 320 in the order of earliest finish time, in the work-conserving manner, by the strict priority scheduler 342.

Through this dual queue structure, the present method may implement an on-time service that guarantees both end-to-end maximum and minimum delays by sequentially performing eligible time control (non-work-conserving) and the finish time-based priority processing (work-conserving).

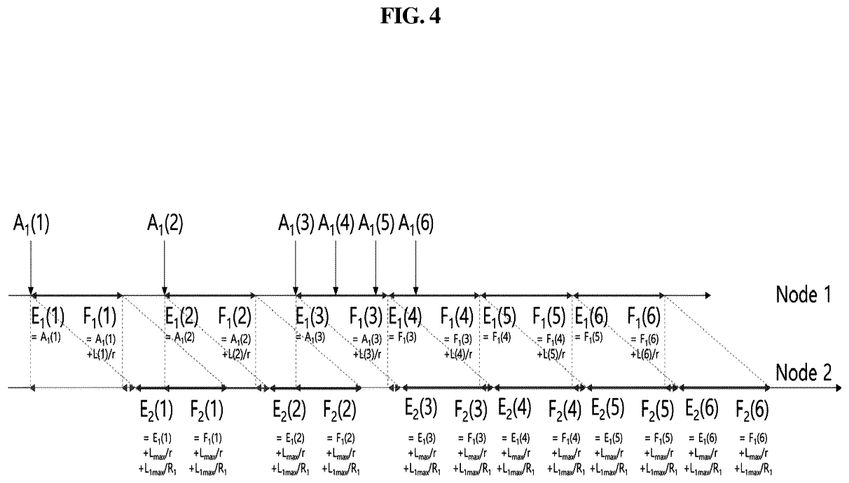

FIG. 4 is a diagram illustrating per-node service periods of the non-work-conserving stateless core fair queuing method according to an embodiment of the present disclosure.

FIG. 4 illustrates how the eligible time and finish time are calculated and propagated for each node during a process of forwarding a packet from an input node (node 1) to a core node (node 2).

Node 1 (input node): At node 1, the eligible time E1(p) and finish time F1(p) of each packet are calculated based on the reception times A1(1), A1(2), A1(3), A1(4), A1(5), and A1(6) of packets and the finish times F1(0), F1(1), F1(2), F1(3), F1(4), and F1(5), of previous packets.

The calculation results for each packet are as follows:

$$E 1 ( 1 ) = A 1 ( 1 ) , F 1 ( 1 ) = A 1 ( 1 ) + L ( 1 ) / r \qquad Packet 1$$

$$E 1 ( 2 ) = A 1 ( 2 ) , F 1 ( 2 ) = A 1 ( 2 ) + L ( 2 ) / r \qquad Packet 2$$

$$E 1 ( 3 ) = A 1 ( 3 ) , F 1 ( 3 ) = A 1 ( 3 ) + L ( 3 ) / r \qquad Packet 3$$

$$E 1 ( 4 ) = F 1 ( 3 ) , F 1 ( 4 ) = F 1 ( 3 ) + L ( 4 ) / r \qquad Packet 4$$

$$E 1 ( 5 ) = F 1 ( 4 ) , F 1 ( 5 ) = F 1 ( 4 ) + L ( 5 ) / r \qquad Packet 5$$

$$E 1 ( 6 ) = F 1 ( 5 ) , F 1 ( 6 ) = F 1 ( 5 ) + L ( 6 ) / r \qquad Packet 6$$

Node 2 (core node): At node 2, the eligible time and finish time of each packet are calculated based on the delay parameters received from Node 1. Formulae for calculating the propagation time between each node are as follows:

### Eligible Time of Next Node:

$${E}_{h + 1} ( p ) = {E}_{h} ( p ) + \frac{L ( p )}{r ( p )} + \frac{{L}_{h}^{max}}{{R}_{h}} + {PD}_{h} \qquad [ Equation 4 ]$$

### Finish Time of Next Node:

$${F}_{h + 1} ( p ) = {F}_{h} ( p ) + \frac{L ( p )}{r ( p )} + \frac{{L}_{h}^{max}}{{R}_{h}} + {PD}_{h} \qquad [ Equation 5 ]$$

Here, L(p)/r(p) denotes the packet service time,

$$\frac{{L}_{h}^{max}}{{R}_{h}}$$

denotes the maximum delay factor at node h, and PDh denotes a link delay between node h and node h+1.

As illustrated in FIG. 4, the calculation result for each packet of node 2 is as follows:

Through this calculation, packets at all nodes maintain the same service period (E(p), F(p)), which is a mechanism that guarantees on-time service, a core feature of the present method. In this example, where the link delay is assumed to be 0, only the processing delay of each node is accumulated to determine the final service period.

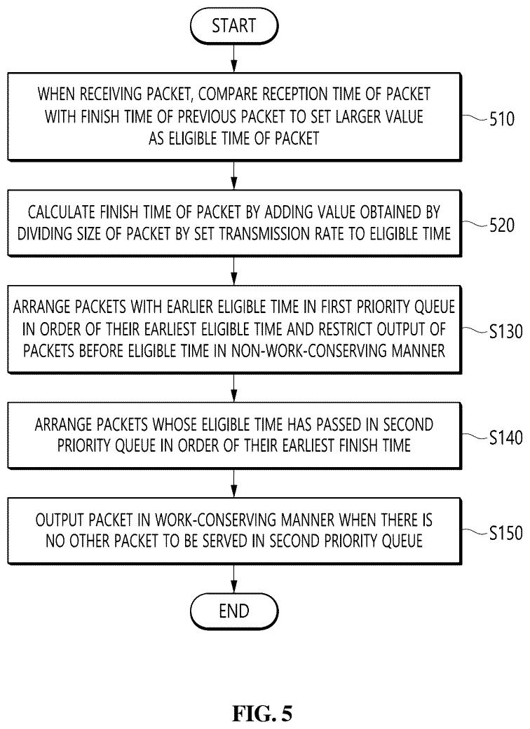

FIG. 5 is a flowchart illustrating an operation of the non-work-conserving stateless core fair queuing method according to an embodiment of the present disclosure.

Referring to FIG. 5, the present method proceeds in the following order.

In step 510, when receiving a packet, the network device compares the reception time of the packet with the finish time of the previous packet to set the larger value as the eligible time of the packet. The input node manages a finish time of a last packet for each flow to determine an eligible time for a newly received packet. When the reception interval of a packet is greater than the service transmission rate, the reception time of the packet is set as the eligible time, and when the reception interval is less than the service transmission rate, the finish time of the previous packet is set as the eligible time.

In step 520, the network device calculates the finish time of the packet by adding the value obtained by dividing the packet size by the set transmission rate to the eligible time. This calculation ensures that each packet has a unique finish time based on the transmission rate, which serves as a criterion for ensuring fair service. Even for flows with non-periodic characteristics, a consistent service period may be provided based on the transmission rate.

In step 530, the network device arranges packets with the earliest eligible time in the first priority queue and restricts the output of packets before the eligible time in a non-work-conserving manner. This step is the core of the present method; even if the link is empty, packets are not transmitted until the eligible time is reached. This may ensure the minimum delay and significantly reduce end-to-end jitter.

In step 540, the network device arranges packets whose eligible time has passed in the second priority queue in the order of their earliest finish time. Packets that have passed the eligible time control are now reordered based on the finish time to prepare to guarantee the maximum delay. During this process, core nodes forward delay parameters by including the delay parameters in a packet header to enable operations without state management for each flow.

In step 550, the network device outputs the corresponding packet in the work-conserving manner if there are no other packets to be served from the second priority queue. This final step operates in the same manner as the existing C-SCORE to maximize the link efficiency. Packets with earlier finish times are processed preferentially, and when the link is empty, the packets are immediately transmitted.

In the present method, state management, such as tracking the finish time and service transmission rate of the previous packet, is performed only at the input node, when the input node calculates in advance delay parameters such as the service transmission rate and an eligible time and finish time of a next node, and forwards the calculated delay parameters and eligible time and finish time as metadata in the packet header, all other core nodes use, without performing their own state management, the eligible time and finish time forwarded by the previous node as metadata in the packet header as their own eligible time and finish time after applying the time difference with the previous node, and the eligible time and finish time of the next node are calculated based on the service transmission rate forwarded as metadata, and then the metadata in the packet header is updated and forwarded to the next node.

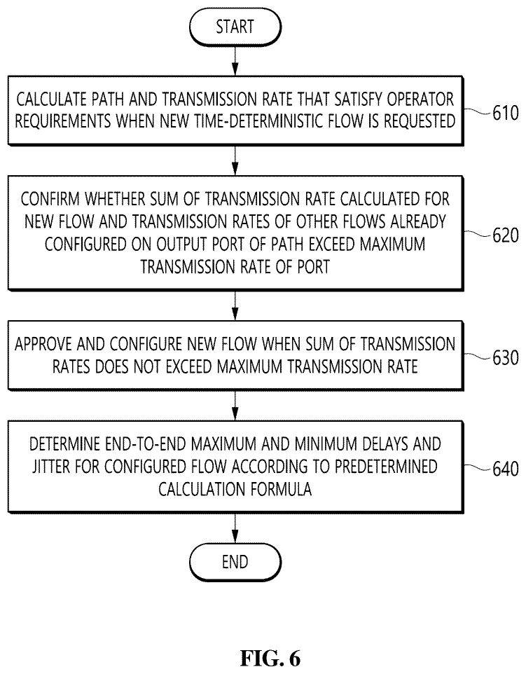

FIG. 6 is an operational flowchart of a time-deterministic packet forwarding control method according to an embodiment of the present disclosure. Referring to FIG. 6, the present method proceeds in the following order.

In step 610, the management device calculates a path and transmission rate that may satisfy an operator's requirements when a new time-deterministic flow is requested. The control system selects an optimal path that satisfies the requirements based on network topology information and available bandwidth of each link. Furthermore, the control system derives a transmission rate that may efficiently utilize network resources while satisfying both the delay and throughput constraints of the requirements.

In step 620, the management device confirms whether the sum of the calculated transmission rate for a new flow and the transmission rates of other flows already configured on the output port of the path exceed the maximum transmission rate of the port. In this step, by performing the admission control solely through simple confirmation based on the transmission rate without complex delay management at the class level, the management complexity is significantly lowered. Unlike the existing class-based methods, only the total transmission rate needs to be confirmed for each port, thereby significantly reducing computational complexity.

In step 630, the management device approves and configures a new flow when the sum of the transmission rate does not exceed the maximum transmission rate. For the approved flow, the corresponding flow information is forwarded to each node on the network, the transmission rate set for the flow is also forwarded to the input node, and the transmission rate and the finish time of the previous packet configured for the non-work-conserving stateless core fair queuing method are managed.

In step 640, the management device may calculate the end-to-end maximum delay, minimum delay, and jitter for the configured flow according to a predetermined formula. The end-to-end maximum delay is calculated by adding the sum of the transmission delays and link delays at each node to the value obtained by dividing the sum of the burst size and the packet size by the transmission rate, and the end-to-end minimum delay is calculated by adding the value obtained by dividing the minimum packet size by the maximum transmission rate of the final node to the sum of the transmission delays and link delays at each node. The jitter is determined by the difference between the maximum and minimum delays, thereby allowing the operator to identify the performance characteristics of the configured flow in advance.

By this control method, it is possible to allow a network manager to efficiently provide time-deterministic services without complex state management or time synchronization, and construct a scalable management system even in large-scale flow environments.

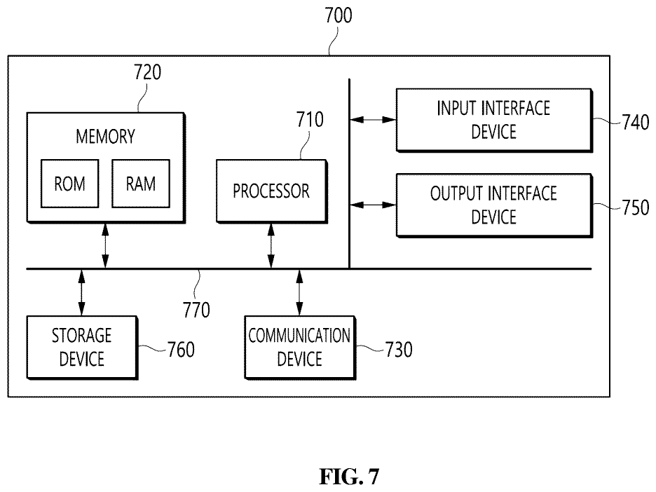

FIG. 7 is a configuration diagram of the time-deterministic packet forwarding apparatus according to an embodiment of the present disclosure. Referring to FIG. 7, a network device 700 may include at least one processor 710, a memory 720, and a transceiver 730 connected to a network and performing communication. Furthermore, the network device 700 may further include an input interface device 740, an output interface device 750, a storage device 760, and the like. The components included in the network device 700 may be connected to each other via a bus 770 and communicate with each other.

However, each component included in the network device 700 may be connected via individual interfaces or individual buses centered around the processor 710, rather than via the common bus 770. For example, the processor 710 may be connected to at least one of the memory 720, the transceiver 730, the input interface device 740, the output interface device 750, and the storage device 760 via a dedicated interface.

The processor 710 may execute program instructions stored in at least one of the memory 720 and the storage device 760. The processor 710 may be a central processing unit (CPU), a graphics processing unit (GPU), or a dedicated processor on which the methods according to embodiments of the present disclosure are performed.

When the network device 700 performs packet forwarding, in the case of an ingress node, the processor 710 compares the reception time of the packet with the finish time of the previous packet when receiving the packet, sets the larger value as the eligible time of the packet, and calculates the finish time of the packet by adding the value obtained by dividing the packet size by the set transmission rate to the eligible time. In the case of a core node, the eligible time and finish time transmitted by the previous node via the packet are used. All nodes calculate and transmit the eligible time and finish time for the next node based on their own eligible time and finish time, taking into account the packet length, transmission rate, and propagation delay, among others, for the next node. Furthermore, the processor 710 is configured to perform a non-work-conserving stateless core fair queuing method based on the eligible time, and to perform a work-conserving stateless core fair queuing method based on the finish time.

When the network device 700 operates as a management device, the processor 710 is configured to calculate the path and transmission rate that may satisfy operator requirements when a new time-deterministic flow is requested, and to perform the admission control.

The methods according to the embodiments described in the claims or specification of the present disclosure may be implemented in the form of hardware, software, or a combination of hardware and software.

When implemented in software, a computer-readable storage medium storing one or more programs (software modules) may be provided. One or more programs stored in the computer-readable storage medium are configured to be executable by one or more processors in an electronic device. One or more programs include instructions for causing an electronic device to execute methods according to embodiments described in the claims or specification of the present disclosure.

Such programs (software modules, software) include a random access memory, a non-volatile memory including flash memory, a read only memory (ROM), an electrically erasable programmable read only memory (EEPROM), a magnetic disk storage device, a compact disc-ROM (CD-ROM), a digital versatile discs (DVD), any other form of optical storage device, and a magnetic cassette. Alternatively, they may be stored in a memory composed of a combination of some or all thereof. In addition, each memory component may be included in plural.

In addition, the program may be stored in an attachable storage device that may be accessed via a communication network such as the Internet, an intranet, a local area network (LAN), a wide area network (WLAN), or a storage area network (SAN), or a combination thereof. Such a storage device may be connected to a device implementing an embodiment of the present disclosure via an external port. In addition, a separate storage device on the communication network may be connected to the device implementing the embodiment of the present disclosure.

In the specific embodiments of the present disclosure described above, components included in the disclosure are expressed in the singular or plural according to the specific embodiments presented. However, the singular or plural expression is appropriately selected for the context presented for convenience of description, and the present disclosure is not limited to the singular or plural components, and a component expressed in plural may be configured in singular, or a component expressed in singular may be configured in plural.

Meanwhile, although specific embodiments have been described in the detailed description of the present disclosure, various modifications are possible without departing from the scope of the present disclosure. Therefore, the scope of the present invention should not be construed as being limited to the described exemplary embodiments but is defined by the appended claims as well as equivalents thereto.

What is claimed is:

1. A non-work-conserving stateless core fair queuing method for providing an on-time service that guarantees end-to-end maximum and minimum delays in a network, the non-work-conserving stateless core fair queuing method comprising:
when receiving a packet, comparing a reception time of the packet with a finish time of a previous packet to set a larger value as an eligible time of the packet;
calculating a finish time of the packet by adding a value obtained by dividing a size of the packet by a set transmission rate to the eligible time;
arranging packets with an earlier eligible time in a first priority queue in order of their earliest eligible time and restricting an output of the packets before the eligible time in a non-work-conserving manner;
arranging packets whose eligible time has passed in a second priority queue in order of their earliest finish time; and
outputting the packet in a work-conserving manner when there is no other packet to be served in the second priority queue.

2. The non-work-conserving stateless core fair queuing method of claim 1, further comprising, managing a finish time of a last packet for each flow at an input node; and transmitting an eligible time and a finish time of a next node calculated at the input node, and a service transmission rate or a delay parameter obtained by dividing the size of the packet by the service transmission rate which are included in a packet header so that subsequent core nodes operate without state management for each flow.

3. The non-work-conserving stateless core fair queuing method of claim 1, further comprising, calculating, at the input node, the eligible time and the finish time of the next node in advance and forwarding the eligible time and the finish time as metadata in the packet header, operating the core nodes based on the eligible time and finish time of the metadata, and updating and forwarding an eligible time and a finish time for the next node.

4. The non-work-conserving stateless core fair queuing method of claim 1, further comprising, since the end-to-end maximum and minimum delays and jitter are determined based on a link delay and a service transmission rate of the end-to-end path according to a predetermined formula, when a new flow is requested, calculating a path and a transmission rate that satisfy requirements, and performing admission control based only on whether a sum of transmission rates of flows configured for each port on the path exceeds a maximum transmission rate of the port.

5. A non-work-conserving stateless core process queuing apparatus for providing an on-time service that guarantees end-to-end maximum and minimum delays in a network, the non-work-conserving stateless core process queuing apparatus comprising:
a transceiver; and
a processor operatively connected to the transceiver,
wherein the processor is configured to, when receiving a packet, compare a reception time of the packet with a finish time of a previous packet to set a larger value as an eligible time of the packet,
calculate a finish time of the packet by adding a value obtained by dividing a size of the packet by a set transmission rate to the eligible time,
arrange packets with an earlier eligible time in a first priority queue in order of their earliest eligible time and restrict an output of the packets before the eligible time in a non-work-conserving manner,
arrange packets whose eligible time has passed in a second priority queue in order of their earliest finish time, and
output the packet in a work-conserving manner when there is no other packet to be served in the second priority queue.

6. The non-work-conserving stateless core fair queuing apparatus of claim 5, wherein the processor is configured to manage a finish time of a last packet for each flow at an input node, and transmit an eligible time and a finish time of a next node calculated at the input node, and a service transmission rate or a delay parameter obtained by dividing the size of the packet by the service transmission rate which are included in a packet header so that subsequent core nodes operate without state management for each flow.

7. The non-work-conserving stateless core fair queuing apparatus of claim 5, wherein the processor is configured to calculate, at the input node, the eligible time and the finish time of the next node in advance, forward the eligible time and the finish time as metadata in the packet header, operate the core nodes based on the eligible time and finish time of the metadata, and update and forward an eligible time and a finish time for the next node.

8. The non-work-conserving stateless core fair queuing apparatus of claim 5, wherein, since the end-to-end maximum and minimum delays and jitter are determined based on a link delay and a service transmission rate of the end-to-end path according to a predetermined formula, when a new flow is requested, the processor is configured to calculate a path and a transmission rate that satisfy requirements, and perform admission control based only on whether a sum of transmission rates of flows configured for each port on the path exceeds a maximum transmission rate of the port.

9. A method of time-deterministic packet forwarding control using non-work-conserving stateless core fair queuing in a network, the method comprising:
calculating a path and a transmission rate that satisfy operator requirements when a new time-deterministic flow is requested;
confirming whether a sum of a transmission rate calculated for the new flow and transmission rates of other flows already configured on an output port of the path exceed a maximum transmission rate of the port;
approving and configuring the new flow when the sum of the transmission rates does not exceed the maximum transmission rate; and
determining end-to-end maximum and minimum delays and jitter for the configured flow according to a predetermined calculation formula.

10. The method of claim 9, comprising calculating the end-to-end maximum delay as a value obtained by adding a value obtained by dividing a difference between a burst size of the flow and a maximum packet size by a transmission rate, a value obtained by dividing a maximum packet size configured at each node on a path by a transmission rate of an output port, a value obtained by dividing a packet length by the transmission rate, and a sum of link delays; and calculating the end-to-end minimum delay as a value obtained by adding a sum of link delays on the path, a sum, up to an immediately preceding node on the path, of values obtained by dividing a maximum packet size configured at each node by the transmission rate of the output port and dividing the packet length by the transmission rate, and a value obtained by dividing a minimum packet size by a maximum transmission rate of a final node.

11. An apparatus for time-deterministic packet forwarding control using non-work-conserving stateless core fair queuing in a network, the apparatus comprising:
a transceiver; and
a processor operatively connected to the transceiver,
wherein the processor is configured to calculate a path and a transmission rate that satisfy operator requirements when a new time-deterministic flow is requested,
confirm whether a sum of a transmission rate calculated for the new flow and transmission rates of other flows already configured on an output port of the path exceed a maximum transmission rate of the port,
approve and configure the new flow when the sum of the transmission rates does not exceed the maximum transmission rate, and
determine end-to-end maximum and minimum delays and jitter for the configured flow according to a predetermined calculation formula.

12. The apparatus of claim 11, wherein the processor is configured to calculate the end-to-end maximum delay as a value obtained by adding a value obtained by dividing a difference between a burst size of the flow and a maximum packet size by a transmission rate, a value obtained by dividing a maximum packet size configured at each node on a path by a transmission rate of an output port, a value obtained by dividing a packet length by the transmission rate, and a sum of link delays; and calculate the end-to-end minimum delay as a value obtained by adding a sum of link delays on the path, a sum, up to an immediately preceding node on the path, of values obtained by dividing a maximum packet size configured at each node by the transmission rate of the output port and dividing the packet length by the transmission rate, and a value obtained by dividing a minimum packet size by a maximum transmission rate of a final node.
